(19) United States
(12) Patent Application Publication
(10) Pub. No.: US 2009/0141164 A1
(43) Pub. Date: Jun. 4, 2009

(54) Reduced-component flash assembly for a digital image capturing apparatus, and a digital image capturing apparatus including the same

(75) Inventors: Hong-ki Moon, Changwon-city (KR); Inh-seok Suh, Changwon-city (KR)

Correspondence Address: DRINKER BIDDLE & REATH LLP;ATTN: PATENT DOCKET DEPT., 191 N. WACKER DRIVE, SUITE 3700, CHICAGO, IL, 60606, US

(73) Assignee: Samsung Techwin Co., Ltd., Changwon-city (KR)

(21) Appl. No.: 12/290,184

(22) Filed: Oct. 28, 2008

(30) Foreign Application Priority Data
Dec. 4, 2007 (KR) 10-2007-0125185

(51) Int. Cl. H04N 5/222

(52) U.S. Cl. 348/371; 348/E05.022

(57) ABSTRACT

A reduced-component flash assembly for a digital image capturing apparatus, and a digital image capturing apparatus including the same are provided. The digital image capturing apparatus includes a frame; a flash module including a flash lamp which is capable of emitting a flash and a flash lamp housing which contains the flash lamp; a top PCB fitted with the flash module, which is disposed on a top part of the frame, on which a flash lamp control component controlling the flash lamp is mounted, and on which a button correspondence component corresponding to a button disposed on a top part of the digital image capturing apparatus is mounted; and a main PCB which is disposed in a side part of the frame, which is electrically connected to the top PCB, and on which a control component controlling the digital image capturing apparatus is mounted.

### CROSS-REFERENCE TO RELATED PATENT APPLICATION

This application claims the benefit of Korean Patent Application No. 10-2007-0125185, filed on Dec. 4, 2007, in the Korean Intellectual Property Office, the disclosure of which is incorporated herein in its entirety by reference.

### BACKGROUND OF THE INVENTION

1. Field of the Invention

The present invention relates to a digital image capturing apparatus, and more particularly, to a digital image capturing apparatus which has a reduced number of components.

2. Description of the Related Art

When used in a capturing mode, a digital image capturing apparatus stores data regarding an image that is obtained during a capturing operation. In a reproduction mode, the digital image capturing apparatus retrieves the data from a storage medium and displays an image on a display unit by using the data stored in the storage medium.

It is difficult to obtain a high quality image using the digital image capturing apparatus when the capturing operation is performed under the condition of less than ideal ambient lighting. In particular, it is difficult to obtain a high quality image when shutter speed is slow due to low light intensity illuminating a target subject, or when a target subject is captured in a back light condition. Thus, the digital image capturing apparatus generally includes a flash lamp so as to emit a flash according to the ambient lighting conditions, thereby improving lighting of the target subject for obtaining a high quality image.

FIG. 1 is a partially exploded perspective view of a conventional flash apparatus of a digital image capturing apparatus. Referring to FIG. 1, the flash apparatus includes a flash bulb or lamp 1, a flash lamp housing 2 for covering the flash lamp 1, a flash lamp holder 3, a gusset 5, and a flexible printed circuit board (FPCB) 4. A component for controlling an operation of the flash lamp 1 is mounted on the FPCB 4. The FPCB 4 electrically connects the flash lamp 1 to a main PCB of the digital image capturing apparatus, thereby enabling the operation of the flash lamp 1 to be controlled by a control unit (on the main PCB) of the digital image capturing apparatus. In particular, in the case of the conventional digital image capturing apparatus, the FPCB 4 is not directly connected to the main PCB but instead is connected to the main PCB via a separate component such as a connector (not shown).

However, when manufacturing the conventional digital image capturing apparatus including the flash apparatus illustrated in FIG. 1, the number of components is increased, the manufacturing process is not easy due to a complicated structure, a yield rate is low, manufacturing costs are greatly increased, and there is a higher probability that some completed digital image capturing apparatuses may be defective. Accordingly, a reduced-component flash apparatus for a digital image capturing apparatus (and a digital image capturing apparatus including such a reduced-component flash apparatus) would be an important improvement in the art.

### SUMMARY OF THE INVENTION

The present invention provides a digital image capturing apparatus which has a reduced number of components so that manufacture thereof is simplified and manufacturing costs are reduced.

According to an aspect of the present invention, there is provided a digital image capturing apparatus comprising a flash lamp, the digital image capturing apparatus including a frame; a flash module including the flash lamp which is capable of emitting a flash and a flash lamp housing which contains the flash lamp; a top PCB (printed circuit board) which is fitted with the flash module, which is disposed on a top part of the frame, on which a flash lamp control component controlling the flash lamp is mounted, and on which a button correspondence component corresponding to a button disposed on a top part of the digital image capturing apparatus is mounted; and a main PCB which is disposed in a side part of the frame, which is electrically connected to the top PCB, and on which a control component controlling the digital image capturing apparatus is mounted.

One of the flash module and the top PCB may include a fitting hole and the other may include a hook corresponding to the fitting hole.

The digital image capturing apparatus may further include a first connection component which connects the flash module and the top PCB whereby the flash module and the top PCB securely fit together.

The flash module and the top PCB may respectively further include a first terminal unit and a second terminal unit which may be soldered together so as to be connected to each other.

The digital image capturing apparatus may further include a second connection component which connects the top PCB and the frame.

The digital image capturing apparatus may further include a capacitor which is electrically connected to the top PCB or the flash module.

The capacitor may be soldered so as to be connected to the top PCB.

The digital image capturing apparatus may further include a third connection component which connects the main PCB and the frame.

The top PCB and the main PCB may respectively further include a first connector and a second connector which are electrically connected to each other whereby the top PCB and the main PCB are electrically connected to each other.

The top PCB and the main PCB may be respectively connected to the frame whereby the first connector and the second connector are engaged with each other.

### BRIEF DESCRIPTION OF THE DRAWINGS

FIG. 1 is an exploded perspective view of a flash apparatus of a conventional digital image capturing apparatus;

FIG. 2 is a partially exploded perspective view of a flash module and a top printed circuit board (PCB) which are included in a digital image capturing apparatus according to an embodiment of the present invention;

FIG. 3 is a perspective view of the flash module and the top PCB assembly of FIG. 2 in an assembled configuration;

FIG. 4 illustrates how the flash module and top PCB assembly of FIG. 3 are configured on a frame of a digital image capturing apparatus according to an embodiment of the present invention;

FIG. 5 is a partially exploded front perspective view of a main PCB and a lens barrel which are included in the digital image capturing apparatus according to the embodiment of the present invention;

FIG. 6 is a front perspective view of the main PCB and lens barrel of FIG. 5 in an assembled configuration;

FIG. 7 illustrates assembly of the main PCB and lens barrel of FIG. 6 with the frame, flash module and top PCB assembly of FIG. 4; and

FIG. 8 illustrates the components shown in FIG. 7 in an assembled configuration.

### DETAILED DESCRIPTION OF THE INVENTION

The present invention will now be described more fully with reference to the accompanying drawings, in which exemplary embodiments of the invention are shown.

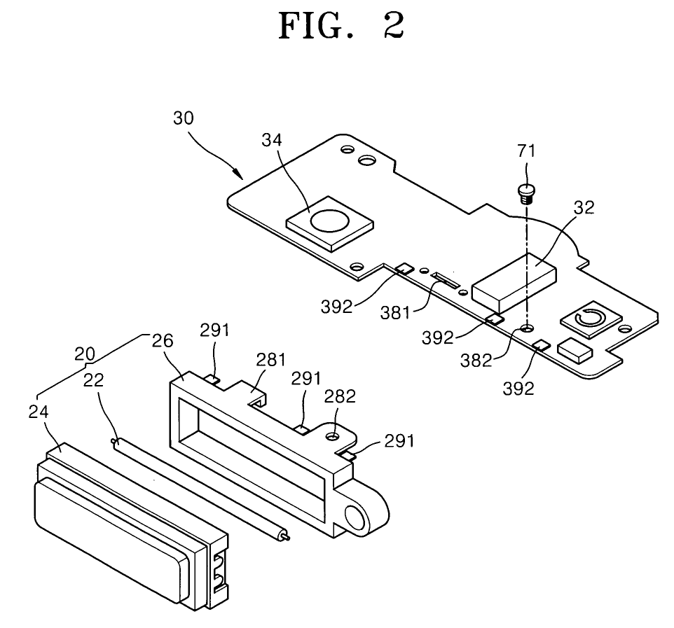

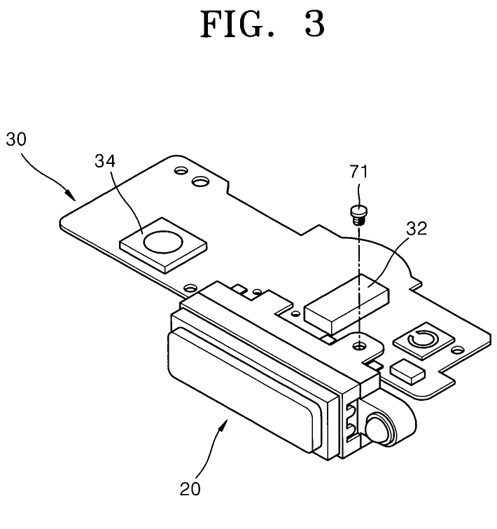

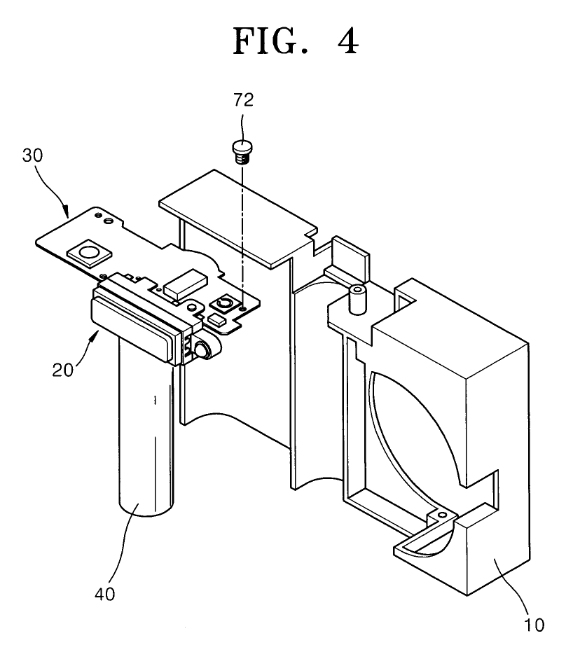

FIG. 2 is a partially exploded perspective view of a flash assembly that is included in a digital image capturing apparatus according to an embodiment of the present invention. As shown, the present flash assembly includes a flash module 20 and a top printed circuit board (PCB) 30 FIG. 3 is a perspective view of the flash assembly showing the flash module 20 and the top PCB 30 of FIG. 2 in an assembled configuration. FIG. 4 shows how the flash assembly of FIG. 3 is installed on a frame 10 of the digital image capturing apparatus.

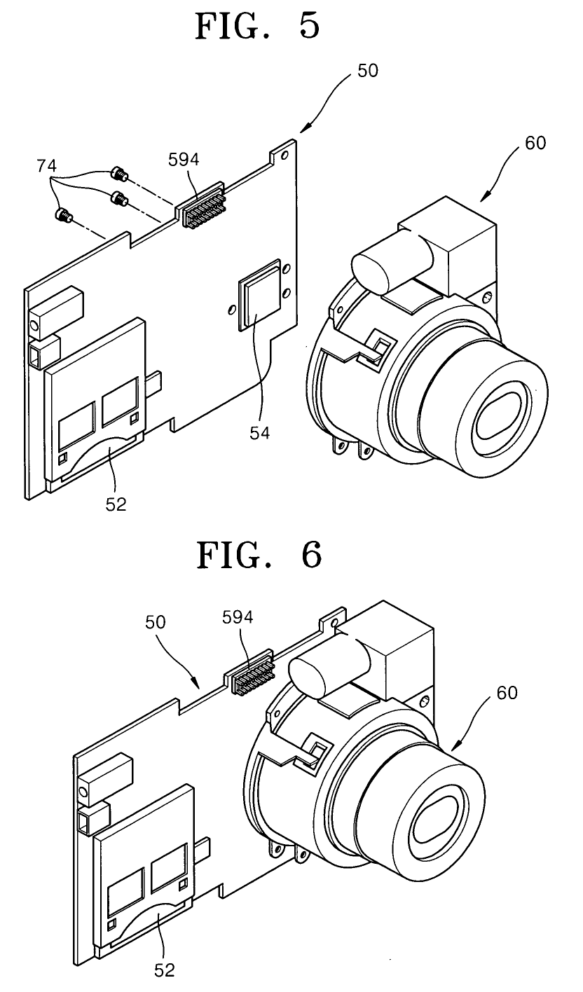

Referring to FIGS. 2 through 4, the digital image capturing apparatus according to the present invention includes the frame 10, the flash assembly (including flash module 20 and top PCB 30) disposed on a top part of the frame 10, and a main PCB 50 (refer to FIGS. 5 through 8) disposed on a side part of the frame 10.

The flash assembly is formed by coupling, connecting, engaging or otherwise fitting the flash module 20 and the top PCB 30 together. The flash module 20 includes a flash bulb or lamp 22 which can emit a flash light, and includes a flash lamp housing which contains the flash lamp 22. As shown in FIG. 2, the flash lamp housing includes a front housing portion 24 and a rear housing portion 26. The front housing portion 24 may include a translucent or transparent member such as a lens (e.g., a Fresnel lens). As further shown in FIG. 2, the top PCB 30 includes: a flash lamp control component 32 for controlling the flash lamp 22, and a button correspondence component 34 (e.g., microswitch, snap dome, etc.) corresponding to a button disposed on a top part of the digital image capturing apparatus. As shown, the flash lamp control component 32 and the button correspondence component 34 are mounted on the top PCB 30 that is fitted with the flash module 20.

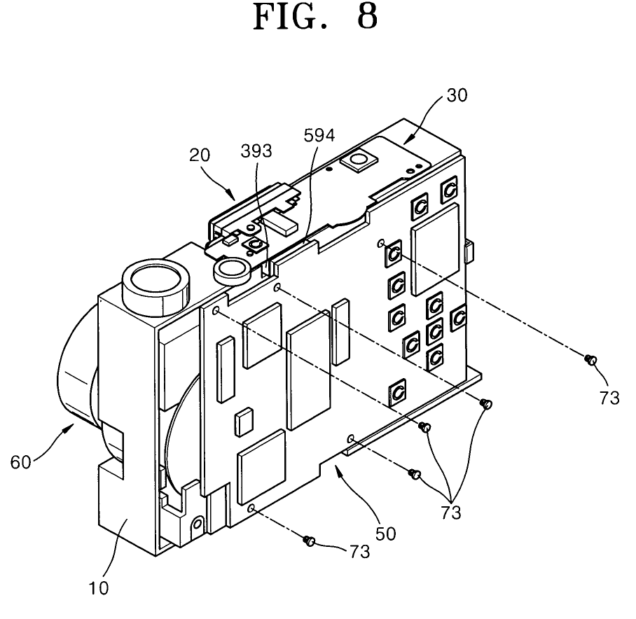

As shown in FIG. 8, the main PCB 50 is disposed on the side part of the frame 10, and is electrically connected to the top PCB 30. A control component 52 (FIGS. 5 and 6), for controlling at least one of an imaging device and the digital image capturing apparatus, is mounted on the main PCB 50.

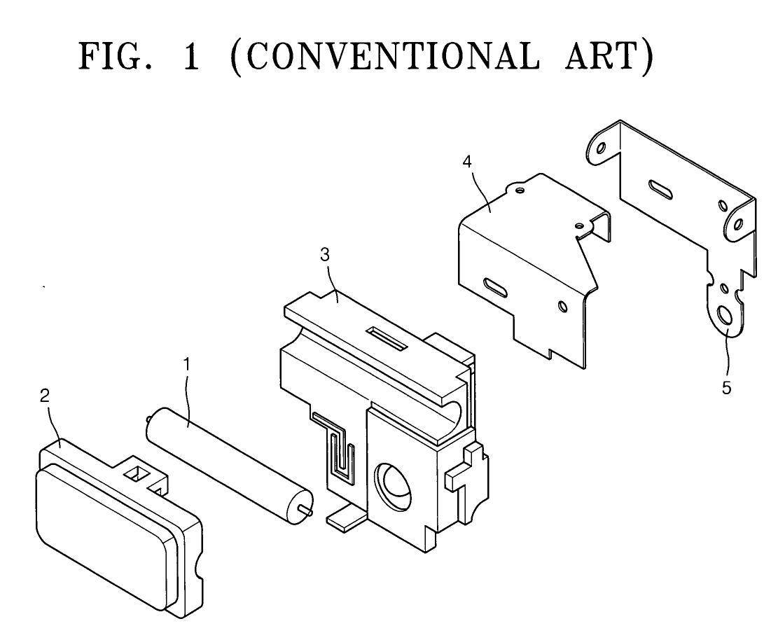

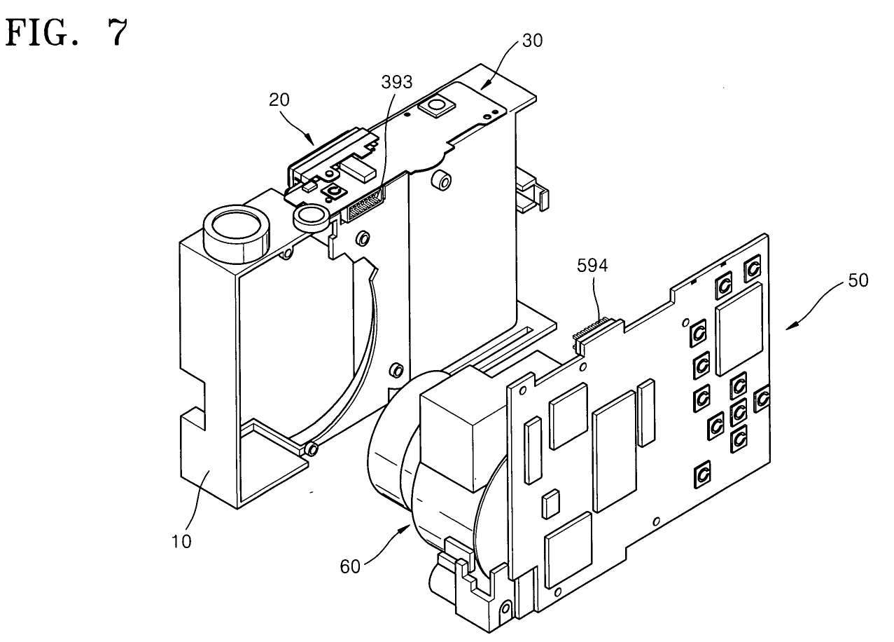

In the case of the digital image capturing apparatus according to the present invention, the flash module 20, that includes the flash lamp 22, and the top PCB 30 physically fit together. Then, the top PCB 30 is electrically connected to the main PCB 50 so that the flash module 20 is also electrically connected to the main PCB 50 via the top PCB 30. As can be appreciated from FIGS. 7 and 8, the top PCB 30 is electrically connected to the main PCB 50 via connectors 393 and 594, connector 393 being electrically connected with the top PCB 30 and connector 594 being electrically connected with the main PCB50. Thus, unlike a conventional digital image capturing apparatus illustrated in FIG. 1, the digital image capturing apparatus according to the present invention does not require a flexible printed circuit board (FPCB) 4, a gusset 5 or a connector (not shown) which connects the FPCB 4 and a main PCB. The conventional digital image capturing apparatus illustrated in FIG. 1 also includes a top PCB on which a button correspondence component, corresponding to a button disposed on a top part of the conventional digital image capturing apparatus, and other components are mounted. Thus, compared to the conventional digital image capturing apparatus, in the case of the digital image capturing apparatus according to the present invention, the total number of components is reduced without additional separate components so that a structure is simplified, manufacture is more easily performed, a post failure occurrence rate is reduced, and manufacturing costs in mass production are greatly reduced.

In the digital image capturing apparatus according to the present invention, the flash module 20 and the top PCB 30 may fit together by using various methods. For example, one of the flash module 20 and the top PCB 30 may include a fitting hole whereas the other one includes a hook corresponding to the fitting hole. Then, the hook and the fitting hole fit together so that the flash module 20 and the top PCB 30 are properly aligned and fit together. As shown in FIG. 2, the top PCB 30 and the flash module 20 respectively include a fitting hole 381 (a rectangular slot or aperture as shown) and a hook 281 (a sideways L-shaped projection as shown) corresponding to the fitting hole 381 so that the hook 281 of the flash module 20 is fitted with the fitting hole 381 of the top PCB 30, thereby properly aligning and fitting together the top PCB 30 and the flash module 20. By having such a structure, the flash module 20 may be consistently fitted at a desired position of the top PCB 30 when the top PCB 30 and the flash module 20 fit together.

The digital image capturing apparatus according to the present invention may include a first connection component 71 (a fastener such as a screw shown in FIG. 3) which connects the flash module 20 and the top PCB 30 via a connection hole 282 of the flash module 20 and a connection hole 382 of the top PCB 30, so that the flash module 20 and the top PCB 30 may securely fit together. Also, the digital image capturing apparatus according to the present invention may be modified by further including a second connection component 72 (a fastener such as a screw shown in FIG. 4) which connects the top PCB 30 and the frame 10 (particularly the cylindrical screw boss shown on the depressed area of the top portion of the frame 10) so that the top PCB 30 and the frame 10 may securely connect to each other.

Meanwhile, unlike the conventional digital image capturing apparatus in which a flash lamp control component for controlling an operation of a flash lamp 1 is disposed on the separate FPCB 4 and the flash lamp 1 is electrically connected to the FPCB 4, the flash module 20 of the digital image capturing apparatus according to the present invention is electrically connected to a flash lamp control component 32 (FIG. 2) of the top PCB 30. For this purpose, the flash module 20 and the top PCB 30 respectively include a first terminal unit 291 (e.g., three electrically conductive members as shown) and a second terminal unit 392 (e.g., three electrically conductive pads as shown), and the first terminal unit 291 and the second terminal unit 392 may be electrically connected (e.g., by solder or by configuring the units 291, 392 in physical contact with each other) so as to be connected to each other. Unlike the conventional digital image capturing apparatus in which the flash lamp 1 is connected to the main PCB via the FPCB 4 and the connector, the flash lamp 22 in the flash module 20 of the digital image capturing apparatus according to the present invention is connected to the main PCB 50 via the top PCB 30. In such a case, the flash lamp 22 may be connected to the main PCB 50 via the top PCB 30 by using an electrical connection between the first terminal unit 291 and the second terminal unit 392.

As known in the art, the flash lamp 22 momentarily emits a flash that is a light of strong intensity. For this purpose, as illustrated in FIG. 4, the digital image capturing apparatus according to the present invention may further include a capacitor 40 that is electrically connected to the top PCB 30, or that is physically and electrically connected to the flash module 20. In this case, the capacitor 40 may be soldered so as to be connected to the top PCB 30.

FIG. 5 is a partially exploded front perspective view of the main PCB 50 and a lens barrel 60 which are included in the digital image capturing apparatus according to the present invention. FIG. 6 is a perspective view of a main PCB-lens barrel assembly 50, 60 in which the main PCB 50 and the lens barrel 60 in FIG. 5 are connected to each other. Referring to FIGS. 5 and 6, various main components such as a digital signal processing unit 52 are mounted on the main PCB 50. Also, an imaging device 54 generating an electrical signal from an accepted light may be mounted on the main PCB 50. The lens barrel 60 includes a lens, a diaphragm, and the like. The main PCB 50 and the lens barrel 60 may be connected by using a connection component 74 (e.g., fasteners such as the three screws shown in FIG. 5). As illustrated in FIG. 5, the connection component 74 may be inserted from a rear surface of the main PCB 50 through holes or apertures therein to fix the lens barrel 60 to the main PCB 50 imaging device 54.

FIG. 7 is a partially exploded rear perspective view of the frame 10, the flash assembly (including top PCB 30 and flash module 20) which is connected to the frame 10, and the main PCB-lens barrel assembly 50, 60. FIG. 8 is a rear perspective view of an example in which the main PCB-lens barrel assembly 50, 60 is connected to the frame 10 to which the top PCB 30 is connected. Referring to FIGS. 7 and 8, the main PCB-lens barrel assembly 50, 60 (defined by the main PCB 50 and the lens barrel 60 being connected to each other) is configured in the frame 10 such that the lens barrel 60 projects or extends through a hole or aperture in a front portion of the frame 10 and the main PCB is vertically oriented in a side part of the frame 10. Then, the main PCB 50 and the frame 10 are connected by using a third connection component 73 (e.g., fasteners such as five screws as shown in FIG. 8).

The top PCB 30 includes a first connector 393 as best illustrated in FIGS. 7 and 8, and the main PCB 50 includes a second connector 594 as best illustrated in FIGS. 5 and 6. Upon installing the main PCB-lens barrel assembly 50, 60 on the frame 10, the first connector 393 and the second connector 594 become engaged such that the top PCB 30 and the main PCB 50 are electrically connected to each other. In particular, as illustrated in FIG. 8, the top PCB 30 is connected to the frame 10 on the top part of the frame 10, and the main PCB 50 is connected to the frame 10 on the side part of the frame 10, so that the first connector 393 and the second connector 594 are automatically engaged with each other (referred to as ‘Board to Board connection’) and thus a separate electrical connection means may not be included. In this manner, unlike the conventional digital image capturing apparatus of FIG. 1 in which the flash lamp 1 is electrically connected to the main PCB via the FPCB 4 and the connector (not shown), the digital image capturing apparatus according to the present invention electrically connects the flash module 20 to the main PCB 50 via the top PCB 30. Accordingly, the number of components may be greatly reduced, the structure may be simplified, manufacture may be more easily performed, so that a yield rate of manufacture may be increased, an occurrence of a post failure may be prevented, and manufacturing costs may be considerably reduced.

The present invention can embody a digital image capturing apparatus that has a reduced number of components, that is simple to manufacture, and that has low manufacturing costs.

While this invention has been particularly shown and described with reference to exemplary embodiments thereof, it will be understood by those of ordinary skill in the art that various changes in form and details may be made therein without departing from the spirit and scope of the invention as defined by the appended claims.

What is claimed is:

1. A digital image capturing apparatus comprising:
a frame;
a flash apparatus including a flash module including a flash lamp housing and a flash lamp for emitting a flash, and a top PCB disposed on a top part of the frame and being electrically connected with the flash module, the top PCB including a flash lamp control component for controlling the flash lamp, and a button correspondence component corresponding to a button disposed on a top part of the digital image capturing apparatus; and
a main PCB disposed in a side part of the frame and being electrically connected to the top PCB, the main PCB including a control component controlling the digital image capturing apparatus.

2. The digital image capturing apparatus of claim 1, wherein one of the flash module and the top PCB comprises a fitting hole and the other one comprises a hook corresponding to the fitting hole.

3. The digital image capturing apparatus of claim 1, further comprising a connection component connecting the flash module and the top PCB.

4. The digital image capturing apparatus of claim 1, wherein the flash module and the top PCB respectively further comprise a first terminal unit and a second terminal unit which are electrically connected upon fitting the flash module and the top PCB together.

5. The digital image capturing apparatus of claim 1, further comprising a connection component connecting the top PCB and the frame.

6. The digital image capturing apparatus of claim 1, wherein the flash apparatus further comprises a capacitor electrically connected to at least one of the top PCB and the flash module.

7. The digital image capturing apparatus of claim 6, wherein the capacitor is soldered to the top PCB.

8. The digital image capturing apparatus of claim 1, further comprising a connection component connecting the main PCB and the frame.

9. The digital image capturing apparatus of claim 1, wherein the main PCB includes a first connector and wherein the top PCB includes a second connector, the first and second connectors being configured to engage with each other for electrically connecting the main and top PCBs.

10. The digital image capturing apparatus of claim 9, wherein the first and second connectors are configured to engage with each other upon installing the main PCB and the top PCB on the frame.

11. A flash apparatus for a digital image capturing apparatus comprising:
a flash module including a housing, and a flash lamp within the housing; and
a PCB electrically connected with the flash module, the PCB including a flash lamp control component for controlling the flash lamp, and a button correspondence component corresponding to a button disposed on a top part of the digital image capturing apparatus.

12. The apparatus of claim 11 further comprising a connector for fixing the flash module and the PCB together.

13. The apparatus of claim 11 further comprising a capacitor electrically connected to at least one of the PCB and the flash module.

14. The apparatus of claim 13 wherein the capacitor is soldered to the PCB.

15. The apparatus of claim 11 wherein the housing comprises a lens.

16. The apparatus of claim 15 wherein the lens is a Fresnel lens.

17. The apparatus of claim 11 wherein one of the flash module and the PCB comprises a fitting hole and the other one comprises a hook corresponding to the fitting hole.

18. The apparatus of claim 11, wherein the flash module and the PCB respectively further comprise a first terminal unit and a second terminal unit which are electrically connected upon fitting the flash module and the PCB together.
